(19) United States
(12) Patent Application Publication
(10) Pub. No.: US 2021/0365964 A1
(43) Pub. Date: Nov. 25, 2021

(54) SERVER ANALYZING REVENUE DATA OF STORE AND ANALYSIS METHOD THEREOF

(71) Applicant: LG ELECTRONICS INC., Seoul (KR)

(72) Inventors: Bongmun JANG, Seoul (KR); Sangjin PARK, Seoul (KR); Haesoo LEE, Seoul (KR)

(73) Assignee: LG ELECTRONICS INC., Seoul (KR)

(21) Appl. No.: 16/489,684

(22) PCT Filed: Feb. 19, 2019
(86) PCT No.: PCT/KR2019/001993

§ 371 Date: Aug. 28, 2019

(51) Int. Cl. G06Q 30/02; G06Q 10/04; G06Q 10/06

(52) U.S. Cl. CPC G06Q 30/0202; G06Q 10/06375; G06Q 30/0201; G06Q 10/04

(57) ABSTRACT

A server and method of analyzing store revenue data are disclosed, the server generates time series analysis data including forecast data on increase/decrease in sales using identification information on a store in which a service device is installed, payment information, and operation information.

### TECHNICAL FIELD

The present invention relates to a method and apparatus for analyzing store revenue data.

### BACKGROUND ART

Recently, there are a number of stores provided with plural household appliances to provide services to users. Since such a store manages plural household appliances, an operator of the store has difficulty in ascertaining details of sales generated by each device. In addition, the operator has difficulty in finding a suitable a way to interpret the generated sales for increase in sales.

In order to overcome such a problem, it is necessary to secure information on usage of each device in the store and information on sales generated by the same type of plural stores.

Therefore, a method for analyzing revenue data, which can provide integrated revenue management for stores in which plural household appliances are installed, and an apparatus implementing the same are disclosed herein.

### DISCLOSURE

### Technical Problem

A purpose of the present disclosure is to solve such a problem in the art, and the present disclosure provides a technique in which a server analyzes sales due to plural service devices on a periodic basis to ascertain increase/decrease in sales.

Another purpose of the present disclosure is to provide a technique in which a server conducts a promotion in response to decrease in sales of a store.

Another purpose of the present disclosure is to provide a technique in which a server controls operation of service devices in a store in response to increase/decrease in sales of the store.

The objects of this invention are not limited to t above mentioned objects, and the other objects and advantages of this invention which are not mentioned can be understood by the following description and more clearly understood based on the embodiments of this invention. It will also be readily seen that the objects and the advantages of this application may be realized by the means defined in the claims.

### Technical Solution

In one embodiment of the present invention, a server for analyzing store revenue data generates time series analysis data including forecast data on increase/decrease in sales using identification information on a store in which a service device is installed, payment information, and operation information on the service device.

In one embodiment of the present invention, the server may generate the time series analysis data based on the store or based on stores in a group to which the store belongs.

In one embodiment of the present invention, when decrease in sales is ascertained from the forecast data or when an amount of the decrease in sales or the number of decreased sales is ascertained therefrom, the server may transmit a message indicating that decline in sales is expected to an operation management device.

In one embodiment of the present invention, the server may generate promotion information based on the number of service devices in the store or previous promotion information on the stores in the group.

### Advantageous Effects

According to the embodiments of the present invention, it is possible to predict increase/decrease in sales of a store in which plural service devices are installed.

In addition, according to the embodiments of the present invention, it is possible to conduct a promotion in response to decrease in sales of a store in which plural service devices are installed.

Further, according to the embodiments of the present invention, it is possible to control operation of plural service devices in response to increase/decrease in sales of a store in which the service devices are installed.

It should be understood that the present invention is not limited to the effects described above and various other effects of the present invention can be easily conceived from the features of the present invention by those skilled in the art.

### DESCRIPTION OF DRAWINGS

FIG. 1 shows a configuration of in-store devices according to one embodiment of the present invention.

FIG. 2 is a schematic view of a service device according to one embodiment of the present invention.

FIG. 3 is a schematic diagram of a server according to one embodiment of the present invention.

FIG. 4 is a schematic view of an operation management device 400 according to one embodiment of the present invention.

FIG. 5 is a diagram illustrating a process in which a service device transmits information on operation to a server according to one embodiment of the present invention.

FIG. 6 is a flowchart illustrating a process in which a server generates analysis data using information stored in a database according to one embodiment of the present invention.

FIG. 7 shows time series analysis data output by an operation management device of a store in which a washing machine/drying machine is placed according to one embodiment of the present invention.

FIG. 8 shows weekly analysis data output by an operation management device of a store in which washing machines/drying machines are installed according to one embodiment of the present invention.

FIG. 9 shows monthly analysis data output by an operation management device for a store in which washing machines/drying machines are installed according to one embodiment of the present invention.

FIG. 10 shows quarterly analysis data output by an operation management device for a store where washing machines/drying machines are installed according to one embodiment of the present invention.

FIG. 11 is a diagram illustrating a process of delivering promotion information according to one embodiment of the present invention.

FIG. 12 shows a process in which a server analyzes increase/decrease in sales and transmits an alert message according to one embodiment of the present invention.

FIG. 13 shows a process in which a server analyzes increase/decrease in sales and transmits an alert message according to another embodiment of the present invention.

FIG. 14 shows a process of incorporating the number of operable service devices in a store into time series analysis data according to one embodiment of the present invention.

### DETAILED DESCRIPTION

Hereinafter, embodiments of the present invention will be described with reference to the accompanying drawings such that the present invention can be easily implemented by those skilled in the art. It should be understood that the present invention may be embodied in different ways and is not limited to the following embodiments.

In the drawings, portions irrelevant to the description will be omitted for clarity. Like components will be denoted by like reference numerals throughout the specification. Further, some embodiments of the present invention will be described in detail with reference to the exemplary drawings. Here, like reference numerals are used to denote like elements even when the elements are shown in different drawings. Description of known functions and constructions which may unnecessarily obscure the subject matter of the present invention will be omitted.

It will be understood that, although the terms “first”, “second”, “A”, “B”, “(a)”, “(b)”, etc. may be used herein to describe various elements, components, regions, layers and/or sections, the nature, order, sequence, or number of these elements, components, regions, layers and/or sections should not be limited by these terms. These terms are only used to distinguish one element, component, region, layer or section from another element, component, region, layer or section. In addition, when an element or layer is referred to as being “on,” “connected to,” or “coupled to” another element or layer, it may be directly on, connected to, or coupled to the other element or layer or intervening elements or layers may be present.

It will be understood that, although components may be individually described in each embodiment of the present invention for convenience of explanation, these components may be implemented as one device or module, or one component may be commonly implemented in plural devices or modules.

As used herein, the term “service device” refers to one of plural household appliances installed in a store and each provided with a communication module. Examples of such a service device include washing machines, drying machines, clothes cleaning machines, and the like. In addition, examples of the service device also include computers, laptops, and the like. Further, a plurality of the same or similar types of home appliances disposed in a single store to provide services to users also corresponds to the service device set forth herein.

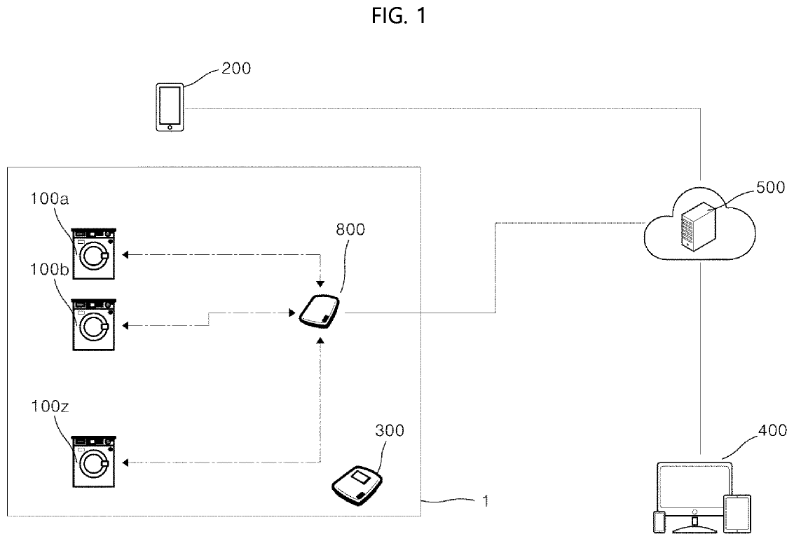

FIG. 1 shows a configuration of in-store devices according to one embodiment of the present invention. For convenience of explanation, the present invention will be described, focusing on a store in which plural commercial washing machines or drying machines are installed and operated. Such a store provides clothes washing/drying services, and sales information thereon is generated from use of the washing machines or drying machines.

A system for managing in-store service devices includes a server 500, an operation management device 400, a customer device 200, service devices 100a, 100b, . . . , 100z, and an Internet access device 800 providing a network connection necessary for data transmission between the service devices and the server 500.

The service device 100 has a communication function, for example, a wireless LAN communication function such as Wi-Fi. Depending on characteristics of stores, the service device 100 may include a separate payment module. Alternatively, a payment device 300 providing an integrated payment function may be disposed in a store 1.

The service device 100 may use various communication protocols, and different types of Internet access devices 800 may be selectively disposed in the store 1 depending upon the type of communication protocols. The plural service devices 100 and the Internet access device 800 are disposed in the store 1.

The Internet access device 800 enables the service devices 100 to be registered in the server 500 or to transmit/receive data to/from the server 500 using a communication protocol. The Internet access device 800 includes an access point or gateway, an Internet hub, a repeater, and the like.

The Internet access device 800 is connected to the service devices by wire or wirelessly and provides a communication function to allow the service devices to communicate with the server 500. In one embodiment, the service device 100 may also be directly connected to the server 500 without any separate Internet access device 800.

The customer device 200 allows a customer inside or outside the store 1 to check usage status of the service device 100 in the store or promotion information on the store 1.

The operation management device 400 allows a store operator to access the server 500 to remotely monitor or control the service devices 100 in the store. In addition, the operation management device 400 may register an account for the store and information on the service devices 100. The operation management device 400 may be disposed inside or outside the store.

Further, the operation management device 400 provides a function of registering an operator account or the store. Moreover, an application may be installed in the operation management device 400 to control and manage installation of the service devices 100 in the store via the Internet access device 800.

In one embodiment, the operation management device 400 may be a computer, a laptop, a smartphone, a tablet, or the like.

The operation management device 400 may control operation of the service device 100 or temporarily cease service provision by the service device 100.

The customer device 200 is a device possessed by a user using the service device 100 in the store or a service provided by the store, and includes an application installed thereon. The customer device 200 may acquire information on the store and register the store therein. The information on the store includes a QR code, a PIN code, unique identification information on the store, or the like.

In addition, the customer device 200 displays current statuses of the service devices 100 in the store or a usage status of a specific service device 100. Further, the customer device 200 may receive an alert message when a service device 100 in use by a user completes a task. The server 500, the service device 100, and the customer device 200 may exchange information.

The server 500 stores information on the store, information on the service device 100, and the like and updates the information. Plural devices 200, 300, 400 may access the server 500 to ascertain the information on the store or to check conditions of the service device 100, and the server 500 may provide a web page or the like to store information necessary for the plural devices 200, 400 to monitor/control the service devices. In addition, the server 500 transmits the stored information to the plural devices 200, 400.

According to the embodiment shown in FIG. 1, a store operator can easily register and manage the service devices in the store and a user can easily acquire information on use of the service devices in the store. In addition, revenue on sales generated from services provided by the service devices in the store can be cumulatively stored in the server 500.

In the embodiment shown in FIG. 1, the server 500 may store and analyze revenue data on plural stores in real time. The server 500 receives information on what functions are provided by the service devices in the store to generate sales, information on an amount of time the service devices are used, information on total revenue of the store, and the like, and stores the information in a database. Then, the server 500 may analyze the data.

For example, the server 500 may store and analyze usage information and sales information on each washing machine/drying machine, which are generated in a store that operates commercial Wi-Fi-enabled washing machines or drying machines.

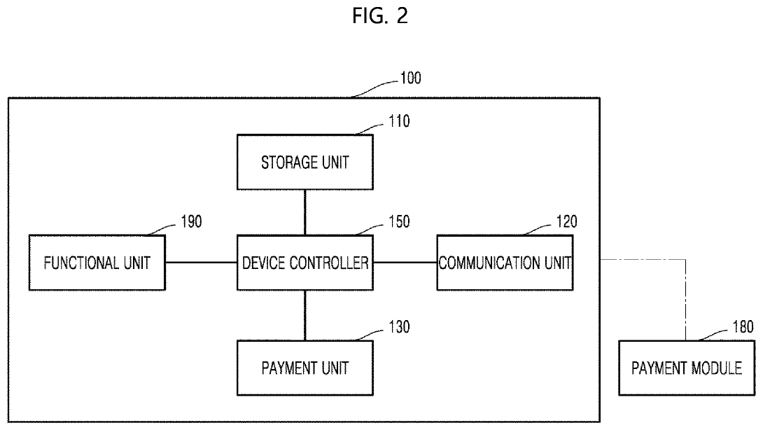

FIG. 2 is a schematic diagram of a server according to one embodiment of the present invention. The server 500 includes: a database 510 storing data necessary for revenue analysis; a communication unit transmitting/receiving data to/from the service device 100, the Internet access device 800, the customer device 200, and the operation management device 400; and a controller 550 controlling the database 510 and the communication unit 520 and generating results of analyzing revenue data.

The controller 550 may analyze a trend on a periodic basis of customers using the store based on revenue data generated by the store for a predetermined period of time and may automatically provide customized services to both the customers and a store operator. Here, the controller may conduct analysis daily, weekly, or by days of week.

In addition, the controller may conduct analysis on a monthly, yearly, or seasonal basis. Further, based on the analysis results, the controller may provide a periodic revenue analysis service and may recommend suitable advertisement/promotion for the store. For this purpose, the controller 550 may generate an notification message related to change in sales for the operation management device 400 of an operator.

In addition, the controller may transmit information on an advertisement or promotion to the customer device 200 in the form of an alarm. Further, the customer device 200 may receive an notification message related to information necessary for use of the service device, and the controller 550 and the database 510 may create or store a condition of an notification message or notification that will be transmitted to the customer device 200.

FIG. 2 is a schematic view of a service device according to one embodiment of the present invention.

A functional unit 190 provides physical functions of the service device 100. For example, when the service device 100 is a washing machine or a drying machine, the functional unit provides a washing function, a drying function, a spin-dry function, and the like. A storage unit 110 stores information necessary for operation of the service device 100. A communication unit 120 transmits/receives information to/from an external server 500. A device controller 150 controls the other components of the service device 100 to operate the service device 100.

A payment unit 130 may be integrated with the service device 100. Alternatively, a payment module 180 providing a payment function to plural service devices 100 in a 1:N relationship may be disposed outside the service device 100 to be physically spaced apart from the service device 100.

The payment module 180 provides a function to pay for services provided by the plural service devices 100. For example, using the payment module 180 disposed in the store to provide only the payment function, a user can pay for use of a service device selected thereby or specified by the payment module 180.

The payment unit 130 or the payment module 180 may provide various payment forms such as inserting cash, paying with credit, debit, or prepaid cards, and paying with e-money.

The service device 100 may provide payment information to the server 500 and may stop operation in response to an instruction of the server 500. For example, it may be necessary to stop service provision by some of the service devices 100 in the store, considering contribution to sales, power consumption, and the like, based on results of analyzing sales by the server 500.

By way of example, it is assumed that, for a store provided with 30 service devices, the server 500 predicts that only 10 service devices will be in operation due to decline in sales. Information on decline in sales may include information on the number of service devices expected to be in operation.

In this case, when the operation management device 400 requests shutdown of some service devices 100 in real time or in advance, the server 500 instructs the corresponding service devices 100 to stop operation. As a result, the corresponding service devices 100 may operate with minimal electricity and may display a notice “under maintenance” on interfaces thereof.

When the number of customers increases again, the server 500 instructs the service devices 100 to resume operation. As a result, the service devices 100 display a notice “maintenance completed” on the interfaces thereof and start operation.

Since operation of the service devices 100 is based on sales of the server 500, the server 500 can selectively operate only some of the plural service devices 100 based on power consumption and sales of the store.

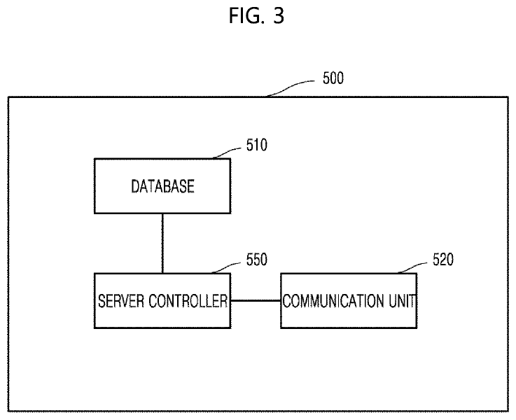

FIG. 3 is a schematic diagram of a server according to one embodiment of the present invention.

The server 500 includes a communication unit 520, a database 510, and a server controller 550.

The communication unit 520 receives payment information and operation information from the service device 100. The database 510 stores the payment information and the operation information.

The server controller 550 generates time series analysis data including forecast data on increase/decrease in sales using identification information on a store in which the service device 100 is installed, the payment information, and the operation information.

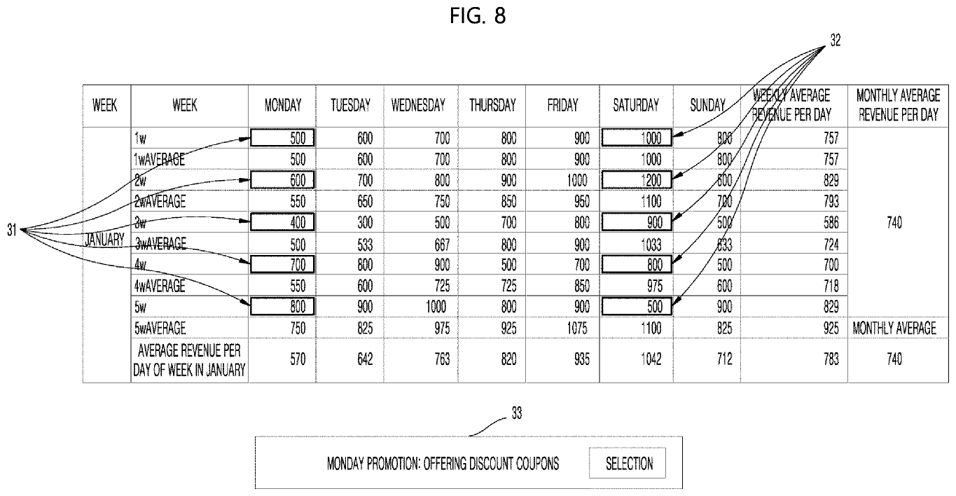

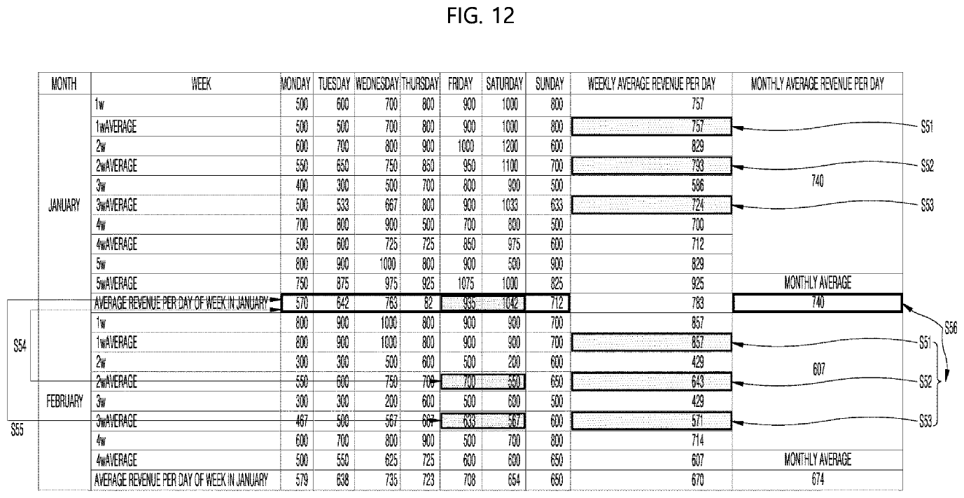

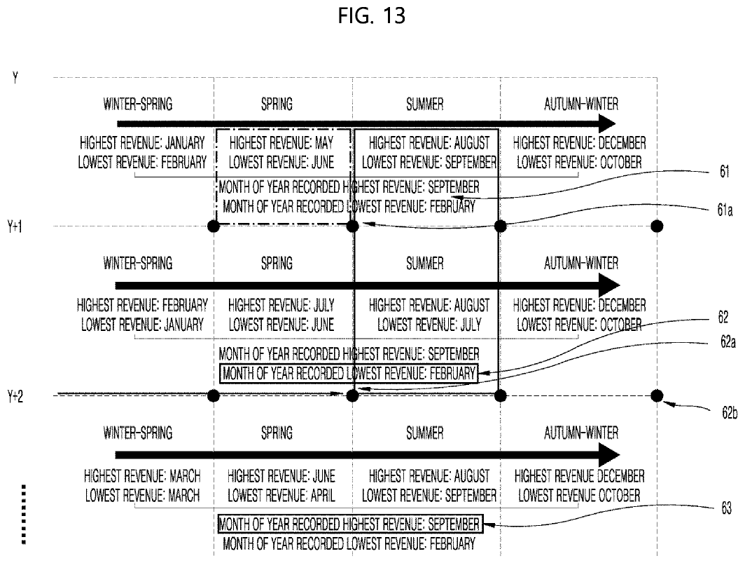

Here, the term “time series analysis data” refers to data obtained by analyzing sales for a certain period of time in time series as shown in FIG. 8 to FIG. 10, FIG. 12 and FIG. 13.

The time series analysis data includes forecast data on increase/decrease in future sales based on daily, weekly, monthly, quarterly, and annual sales results. The time series analysis data may further include forecast data on use of the service devices, in addition to the forecast data on increase/decrease in future sales. For example, when decline in sales is expected, the server controller 550 may calculate the number of service devices operable at a most reasonable cost to reduce the number of available service devices.

In addition, the server controller 550 may generate the time series analysis data based on a corresponding store. Alternatively, the server controller 550 may generate the time series analysis data based on stores belonging to the same group as the corresponding store. As used herein, the expression “based on stores belonging to the same group as the corresponding store” means that comparative sales information on stores other than the corresponding store, such as the other stores operated by the same operator is included in the time series analysis data.

Alternatively, the server controller 550 may set a group consisting of stores that meet certain criteria (for example, existing in the same or similar region, having similar sizes, or the like) despite not being operated by the same operator, and may collect sales information on all stores in the group to generate time series analysis data including average sales of all the stores as the comparative sales information.

By way of example, the server controller 550 may set a group consisting of stores in Seoul, stores in a university town, or stores having service devices whose number falls within a certain range (for example, 10 to 15), and may calculate average sales of the stores in the group to incorporate the average sales into the time series analysis data.

In this case, the operation management device 400 may display whether sales of a corresponding store are on the rise or on the decline in comparison with those of the other stores in the group, and may conduct a promotion in response thereto.

The communication unit 520 transmits the time series analysis data to the operation management device 400.

In the embodiment shown in FIG. 3, the server 500 calculates a trend in sales by cumulatively collating payment information transmitted from each of the service devices 100 in the store and thus can generate accurate time series analysis data.

A group to which a store maintained by the server 500 belongs may be created dynamically. In particular, the server 500 may provide information on sales of stores in the group to the operation management device 400 after removing identification information on the other stores, whereby an operator of a corresponding store can ascertain a sales situation of the store in comparison with other stores in the same group.

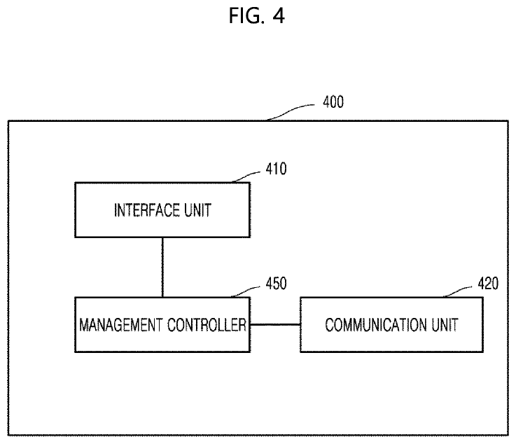

FIG. 4 is a schematic view of an operation management device 400 according to one embodiment of the present invention.

The operation management device 400 includes a computer, a laptop, a smartphone, and the like. An interface unit 410 includes a screen displaying information to output the time series analysis data provided by the server 500. The interface unit 410 may receive a touch input signal. For example, the interface unit 410 registers operator input requesting that the server 500 send promotion information among the time series analysis data or shut down or operate the service device by detecting a touch on the screen. Then, a management controller 450 converts the input signal into information on request for the promotion information or shutdown/operation of the service device. The communication unit 420 transmits the information to the server 500.

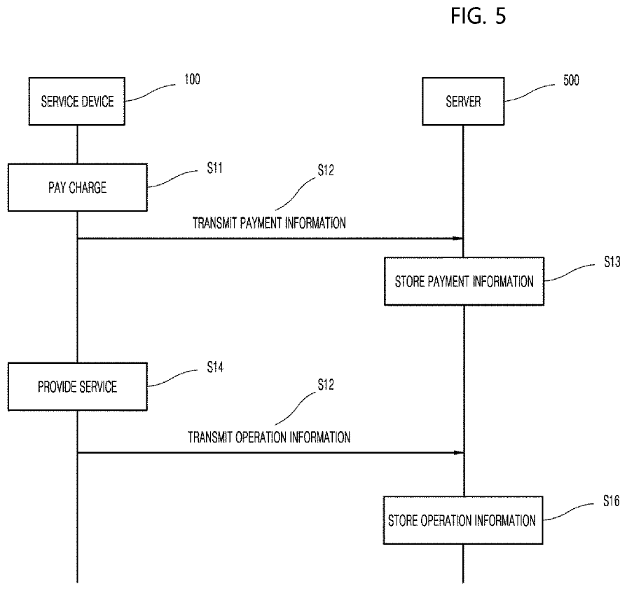

FIG. 5 is a diagram illustrating a process in which a service device transmits information on operation to a server according to one embodiment of the present invention.

In this embodiment, the service device will be exemplified as a washing machine or a drying machine. A user selects a specific service (washing, drying, rinsing, etc.) of the washing machine or drying machine and pays a charge to use the service (S11). Here, the user may use the payment unit 130 attached to the service device 100. Alternatively, the user may pay the charge using the payment module 180 spaced apart from the service device 100.

The communication unit 120 of the service device 100 transmits payment information generated in the process of payment to the server 500. The payment information includes a paid amount, a payment form, an applied promotion, and the like. In addition, the payment information includes store identification information and service device identification information. Further, the payment information may optionally include identification information on a user paying a charge to use a specific service and information on the service.

The server 500 stores the received payment information in the database 510 (S13). Then, the service device 100 controls the functional unit 190 to provide a service (S14). Then, the service device 100 provides a service paid by a user and transmits operation information generated in the process of providing the service to the server 500 (S15).

Here, the operation information includes information on a service provided by the service device 100, i.e., information on a function of the service device 100. For example, when the service device is a washing machine or a drying machine, the operation information includes information on a washing course, a drying course, a washing/drying amount, time required to complete a service, and the like. In addition, the operation information includes information on an abnormality, malfunction, and error that has occurred in the service device 100 during provision of a function. It will be understood that the operation information may include store information and identification information on the service device 100 such that the server 500 and the operation management device 400 can identify which service device 100 has transmitted the operation information.

The server 500 stores the received operation information in the database 510.

The information stored in the server 500 in steps S13 and S16 may be ascertained by a store operator using the operation management device 400. In addition, the store operator may ascertain revenue analysis information and customer trend information provided by the server 500.

The service device 100 may transmit, in real time, the payment information and the operation information to the server 500 at the time of providing a service. Alternatively, the service device 100 may transmit the payment information and the operation information to the server 500 after storing the payment information and the operation information over a predetermined period of time (for example, 1 hour, 6 hours, 1 day, or the like). However, the period of time for which the payment information and the operation information are stored is shorter than a period of time (day/week/month/season/year, etc.), on the basis of which the server 500 generates the time series analysis data.

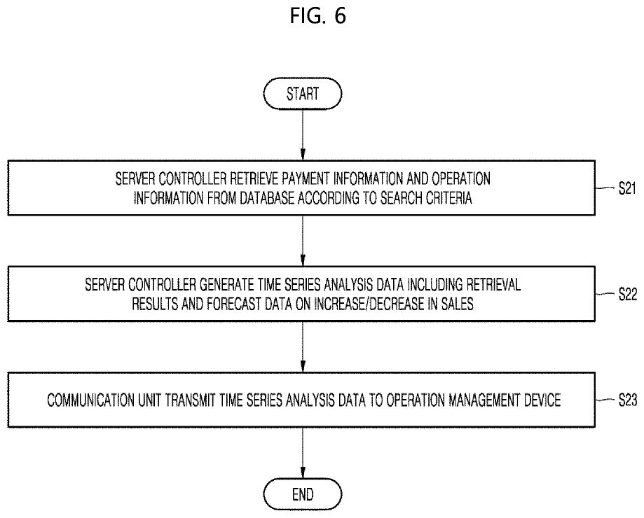

FIG. 6 is a flowchart illustrating a process in which a server generates analysis data using information stored in a database according to one embodiment of the present invention. The server 500 may provide analysis data in response to a request of the operation management device 400 or at pre-arranged time intervals. Here, the analysis data includes revenue analysis data based on data on revenue generated by the store, and periodic information on users using services provided by the store or a periodic trend of the users.

In this embodiment, the service device will be exemplified by a commercial Wi-Fi-enabled washing machine/drying machine. The server 500 performs revenue analysis based on revenue data on a store that operates the washing machine/drying machine (i.e., the payment/operation information stored in the server in FIG. 5). The server 500 automatically analyzes days a large number of customers used the store and days a small number of customers used the store to utilize the analysis results for operation of the store. In addition, the server 500 may analyze weekly/monthly/yearly sales, as well as daily sales.

Further, the server 500 analyzes a trend of customers using the store for a certain period of time based on change in sales of the store, changes in sales of other neighboring stores, and the like.

First, the server controller 550 of the server 500 sets a specific basic period of time for analysis as search criteria. In addition, the server controller 550 adds identification information on a service device to be analyzed, a store to be analyzed, and a specific group of stores to the search criteria.

Herein, the term “specific group of stores” refers to a set of interrelated stores, such as stores located in the same region, stores having the same business range, and stores operated by the same operator. Here, “the same region” is based on geographical locations. A range of “the same area” may be varied, as needed.

In addition, the term “the same business range” reflects characteristics of customers, especially main customers of a corresponding store. By way of example, when a first store is located in an apartment complex and a second store is in front of a university, these two stores may have different business ranges. Main costumers of the first store are families.

On the contrary, main customers of the second store are university students, especially students who live away from home. Accordingly, stores having different customer bases may have different business ranges and stores having the same customer base may belong to the same group.

In addition, stores managed by the same operator may be set into one group. When one operator operates plural stores, the server controller 550 sets search criteria such that sales comparison for each store or sales comparison between all the stores is possible.

The server controller 550 retrieves payment information and operation information from the database according to the search criteria (S21) and generates time series analysis data including retrieval results and forecast data on increase/decrease in sales (S22). Here, the forecast data is data for predicting change in number of users over a certain period of time, and is generated based on past sales revenue.

Alternatively, the forecast data may reflect operational status of a neighboring store. When information indicating that a second store adjacent to a first store did not operate for a week is stored in the server 500, the server controller 550 may generate forecast data indicating that some users of the second store will move to the first store.

The time series analysis data generated by the server controller 550 is based on daily/weekly/monthly/seasonal/annual sales information.

Then, the communication unit 520 transmits the time series analysis data to the operation management device (S23).

When the process shown in FIG. 6 is applied to a store providing services of a washing machine or drying machine, the server stores information on (daily/weekly/monthly/seasonal/annual) revenue generated from operation of each washing machine or drying machine after payment of charges. Then, the server controller 550 provides information on revenue status to the operation management device 400 as the time series analysis data.

The time series analysis data provided to the operation management device 400 is generated through big data analysis. In one embodiment, the time series analysis data includes results of analyzing a trend of store use by users based on average sales in a predetermined search period. In addition, the time series analysis data may also include forecast data suggesting a customized service based on the trend of store use by users.

To this end, the server controller 550 calculates a representative value of sales in the search period (day/week/month/season/year). The representative value includes an average value, a median value, a mode value, and the like. In addition, the server controller 550 may generate the forecast data based on a representative value of a control standard comparable with sales in the search period.

In setting of the control standard, the server controller 550 may set sales in a period preceding the search period as the control standard. For example, sales this month may be compared with sales last month or sales during the same month last year. In addition, sales this week may be compared with sales last week or sales during the same week last month. Such a control standard on a periodic basis may be set variously, and the operation management device 400 may set a range of the control standard and then may transmit information on the set range of the control standard to the server 500.

Alternatively, in setting of the control standard, the server controller 550 may set sales of another store belonging to the same group as the corresponding store in the same period as the control standard.

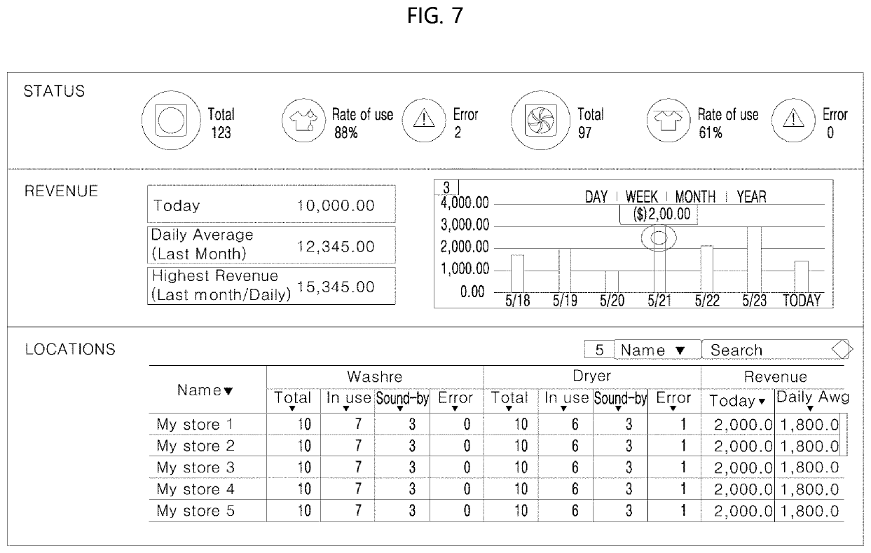

FIG. 7 shows time series analysis data output by an operation management device of a store in which a washing machine/drying machine is installed according to one embodiment of the present invention. In the drawing, item ‘Status’ provides information on the current number, rate of use, and error rate of washing machines and drying machines.

Item ‘Revenue’ provides daily sales (‘Today’), a representative value (e.g., average value) of daily sales last month (‘Daily Average (Last Month)’) based on the control standard, and highest daily sales last month (’Highest Revenue/Last month/Daily)’) based on the control standard.

Item ‘Locations’ indicates a group consisting of plural stores operated by the same operator, if applicable. The operators may click on any one of the plural stores to view time series analysis data on the corresponding store.

According to the embodiments shown in FIG. 6 and FIG. 7, a store operator can check a sales situation of a corresponding store without ascertaining sales from each service device. For example, an operator of a store where commercial Wi-Fi-enabled washing machines or drying machines are installed, as shown in FIG. 1, can easily ascertain a current revenue status of the store using the time series analysis data provided by the server 500 without separately inspecting revenue from each service device, and thus can more efficiency manage the store.

In addition, an operator can predict increase/decrease in number of users using services of a corresponding store based on the forecast data. Accordingly, the operator can encourage registered users to visit during off-peak hours or can conduct a promotion, such as offering discounts or coupons to users visiting the store during the corresponding hours. As a result, it is possible to increase sales of the store and to reduce the time users spend waiting, thus improving user convenience.

FIG. 8 shows weekly analysis data output by an operation management device for a store in which washing machines/drying machines are installed according to one embodiment of the present invention.

As described above, the server 500 generates time series analysis data on a certain periodic basis and the operation management device 400 receives the time series analysis data and outputs the time series analysis data on the interface unit 410. The time series analysis data includes: sales data accumulated on a certain periodic basis, and information on highlighted values of the sales data, wherein the values are sales values in periods in which variation in sales was large. In addition, the time series analysis data may include promotion data 33.

Now, an example of the time series analysis data will be described. In order to generate the time series analysis data, the server controller 550 accumulates payment information transmitted from each service device on a certain periodic basis and compares the payment information with previous payment information accumulated on the same periodic basis. Here, the expression “on the same periodic basis” means that the time series analysis data is generated based on a common repeated time cycle, such as daily/weekly/monthly/quarterly/yearly.

In FIG. 8, sales in January are shown by day of week/weekly. To this end, the server controller 550 generates the time series analysis daily/weekly. That is, the server controller 550 generates information on a day last week or last month on which store revenue was lowest and a day last week or last month on which store revenue was highest and transmits the information to the operation management device 400. The operation management device 400 displays the information on the interface unit 410, wherein the day on which store revenue was lowest is marked, as indicated by reference numeral 31 and the day on which store revenue was highest is marked, as indicated by reference numeral 32. In addition, the server controller 550 may provide promotion data to the operation management device 400, as indicted by box 35.

An operator may ascertain the time series analysis data and the promotion data output on the operation management device 400 and may select a promotion by pressing a selection button as shown in box 33. In this case, the server 500 may transmit the promotion data to users registered in a store that is managed by the operation management device 400.

For example, the communication unit 520 of the server 500 transmits information indicating that the store offers discounts/coupons to the customer devices 200 of users whose phone numbers are registered with the store by SMS/MMS. Alternatively, the communication unit 520 of the server 500 may transmit the promotion data to an application installed on each of the customer devices 200 in the form of a coupon.

As a result, users using the store can view the promotion data such as “Monday promotion-15% discount” on the customer device 200 and thus can plan to visit the store on Monday.

In addition, the operation management device 400 outputting the information shown in FIG. 8 may be, for example, an operator's mobile phone, smartphone, or the like. In this case, the server 500 may transmit a result of analyzing a day last week or last month on which store revenue was lowest/highest to the operator's mobile phone in the form of an notification message.

In addition, the server 500 may incorporate an encrypted link for requesting the promotion in the notification message such that the operator can conduct the promotion through their mobile phone or smartphone.

When the operator presses a selection button as shown in box 33 of FIG. 8, or clicks on a selection link corresponding to the selection button after ascertaining the promotion data through the operation management device 400 such as operator's mobile phone or smartphone, the server 500 transmits information on an advertisement, coupons, or discounts related to the promotion to the customer device 200.

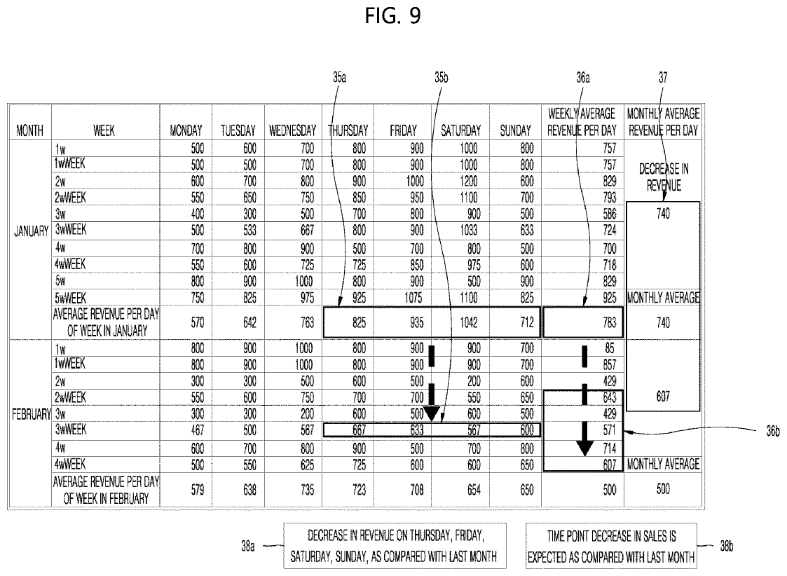

FIG. 9 shows monthly analysis data output by an operation management device for a store in which washing machines/drying machines are installed according to one embodiment of the present invention. The monthly analysis data shown in FIG. 9 is time series analysis data obtained through analysis on a monthly basis.

The server 500 accumulates sales information on the store collected daily/weekly/monthly. The server 500 analyzes increase/decrease in sales based on a certain period. Then, the server 500 transmits information on increase/decrease in sales to the operation management device 400 such that an operator can ascertain increase/decrease in revenue as compared with the past.

The monthly analysis data of FIG. 9 shows days 35b that store revenue was significantly decreased as compared with daily average revenue 35a in last month. The operation management device 400 may output sales information received from the server 500, as shown in FIG. 9. In addition, the operation management device 400 may output weekly average revenue 36b which is continuously decreased as compared with average revenue 36a last month. In addition, the operation management device 400 may output data on decline in monthly average revenue 37.

In the embodiment shown in FIG. 9, the operation management device 400 displays a prediction that revenue this month will be decreased as compared with that last month and results of analyzing main days that store revenue was decreased.

In particular, the server 500 may transmit the analysis results to an operator's smartphone or the like in the form of a message. For example, when weekly revenue this month was decreased as compared with weekly average revenue last month, the server 500 may provide operator's smartphone or the operation management device 400 with a message 38b indicating that decline in revenue is expected this month or a message 38a showing a result of analyzing days that store revenue was less than daily average revenue in last month.

That is, the server controller 550 may ascertain decrease in sales or ascertain an amount of the decrease in sales or the number of decreased sales from the forecast data on increase/decrease in sales, which is included in the generated time series analysis data. In this case, the communication unit 520 of the server may transmit a message indicating that decline in sales is expected, such as the messages 38a, 38b, to the operation management device 400.

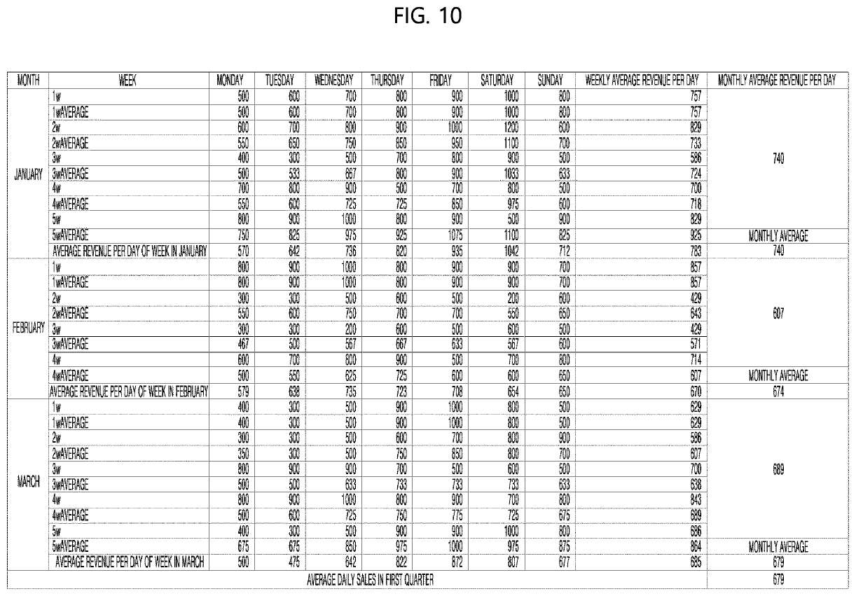

FIG. 10 shows quarterly analysis data output by an operation management device for a store where washing machines/drying machines are installed according to one embodiment of the present invention. The server 500 accumulates information on store' sales collected daily/weekly/monthly based on cumulative payment information on the store and transmits the cumulative results to the operation management device 400. The operation management device 400 outputs the results, as shown in FIG. 10. Here, the operation management device 400 may allow the output results to include highlighted or differently colored values, wherein the values are revenue values in periods in which variation in revenue was large.

The server 500 analyzes a period in which the number of users using the store was largest or smallest through analysis of quarterly (or monthly) revenue and cumulative annual revenue, and transmits an notification message to operator's smartphone. The quarterly data may be calculated on a year-by-year basis. For example, the server 500 may predict that the number of customers using the store will be smallest in February through analysis of customer trends in spring, that is, for the first quarter, and may transmit the predicted results to the operation management device 400 or an operator's smartphone.

As a result, an operator can decide to conduct a promotion to increase sales in February, when low sales are expected. The data shown in FIG. 10 is generated as a result of managing data annually accumulated in the server and thus can have high reliability.

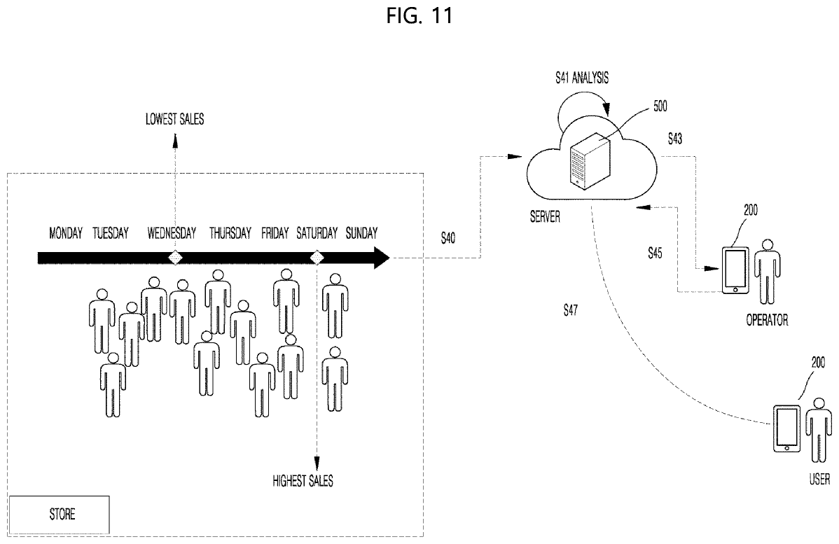

FIG. 11 is a diagram illustrating a process of delivering promotion information according to one embodiment of the present invention. In addition, FIG. 11 illustrates a process in which the communication unit 520 of the server transmits a message indicating that decline in sales is expected to the operation management device 400.

The server 500 receives payment information generated from a corresponding store and cumulatively stores the payment information (S40). In this process, the server 500 analyzes a day of week lowest sales are expected and a day of week highest sales are expected based on cumulative sales information (S41), as shown in FIG. 8 to FIG. 10. In the process of analysis, the server 500 may ascertain and analyze highest revenue per day of week.

When a difference in sales between the day of week lowest sales are expected and the day of week highest sales are expected is greater than or equal to a predetermined reference value, the server 500 transmits an alarm message (a message indicating that decline in sales is expected) to the operation management device 400 (S43). Here, the alarm message includes data on customer trends by day of week, wherein the data is utilized in marketing by an operator.

The message indicating that decline in sales is expected, transmitted in step S43, may include promotion information. For example, an operator ascertains promotion information output by the operation management device 400, such as information on a discount event, and requests the server 500 to conduct a corresponding promotion (S45).

In generation of the promotion information, the server controller 550 may generate the promotion information based on the number of service devices in a corresponding store or previous promotion information on stores in a group to which the store belongs.

Specifically, the server controller 550 may generate the promotion information based on the number of service devices allowing efficient service provision to customers visiting the store. For example, when there are thirty service devices in the store and estimated sales can be generated from ten service devices, the server controller 550 generates promotion information that offers benefits, such as discounts, to users using the other twenty service devices.

In addition, the promotion information includes the number of customer devices capable of reception of the promotion information. The server controller 550 may generate the promotion information based on previous promotion information on the stores in the group to which the corresponding store belongs.

By way of one example, when the store is located in an apartment complex, the server controller 550 may generate the promotion information based on a promotion that was conducted by a different store in a different apartment complex and contributed to increase in sales. By way of another example, when there are fifty service devices in a corresponding store, the server controller 550 may generate the promotion information based on the number of services provided by service devices in a second store in which fifty (or 40 to 50) service devices are installed.

When the communication unit 520 of the server receives a promotion request message from the operation management device 400, the server controller 550 transmits the promotion information to plural customer devices selected from among customer devices that registered with the store based on a predetermined selection criterion. That is, the server controller 550 may transmit the promotion information to all the customer devices registered with the store or may selectively transmit the promotion information to customer devices whose owners are likely to visit the store.

Alternatively, the server controller 550 may select customer devices corresponding to the promotion information. For example, the server controller 550 may select users who frequently used a drying service for large volumes of laundry and may provide the customer device (a mobile phone, a smartphone, etc.) of each of the users with promotion information that offers discounts for the drying service during summer.

The server 500 retrieves information on users who registered the store as a store of interest, and transmits promotion information to the customer devices 200 of the users (S47). Each of the users may ascertain the promotion information output on the customer device 200. For example, the promotion information may include information that offers discounts to users visiting the store on a specific date (or day of week), along with the name of the store. Alternatively, the promotion information may include information on available coupons (and discounts).

The server 500 calculates a day that store revenue was highest and a day that store revenue was lowest during last week/last month (S40, S41) and provides sales information and promotion information to the operation management device 400 (S43). Then, the server 500 transmits the promotion information to the customer device 200 according to operator selection to propagate a corresponding promotion to users using the store. In this process, the server 500 transmits monthly average revenue per day of week or weekly average revenue per day of week to the operation management device 400 such that an operator can determine whether to conduct the promotion.

In particular, the server 500 may store promotion condition information preset by the operation management device 400, and, when a sales situation of the store meets the promotion condition, the server 500 may automatically transmit the promotion information to the customer device 200.

Here, the promotion condition information includes an amount of the decrease in sales of a corresponding store. In addition, the promotion condition information includes a ratio of sales to number of customers visiting the store. Further, the promotion condition information includes an amount of decrease in number of users who registered the store in the server 500 as a store of interest.

FIG. 12 shows a process in which a server analyzes increase/decrease in sales and transmits an alert message according to one embodiment of the present invention.

The server 500 may predict that store revenue will be decreased this month as compared with last month. In addition, the server 500 may analyze main days that decrease in revenue is expected and transmit an notification message to the operation management device 400. The server 500 may apply the same analysis scenario every month/week. Alternatively, the server 500 may apply different analysis scenarios every month/week.

Here, the analysis scenario generates results that predict rise or decline in sales through comparison between cumulative sales for a certain period and cumulative sales for a previous period.

For example, the server 500 compares average weekly revenue of the store with average revenue in the same week last month (S51 to S53). In this process, the server 500 ascertains in step S52/S53 that decrease in sales occurred and continued over two consecutive weeks. When the sales results meet a specific condition that decrease in sales should occur and continue over consecutive periods, the server 500 ascertains days that store sales was less than or equal to average sales during last month (S54, S55). After ascertaining, for example, that decrease in sales occurred on Friday/Saturday in the second week and Friday/Saturday in the third week in February, the server 500 transmits an alarm to the operation management device 400 of an operator. Alternatively, after steps S54, S55, the server 500 compares weekly average revenue per day during this month with monthly average revenue per day during last month (S56). When confirming that store sales show a downward trend from the results of comparison, the server 500 transmits an alert message indicating that sales are on the decline to the operation management device 400 of an operator.

The operator may plan an event in response to decline in sales after checking the alert message received by the operation management device 400.

Alternatively, the server 500 may transmit an alarm message suggesting an event in response to decline in sales to the operation management device 400. In this case, when the operation management device 400 requests the server 500 to conduct the event, the server 500 transmits promotion information on the event to the plural client devices 200.

FIG. 13 shows a process in which a server analyzes increase/decrease in sales and transmits an alert message according to another embodiment of the present invention.

The server 500 analyzes a period for which the number of customers using a corresponding store is largest or smallest through analysis of quarterly (monthly) revenue and cumulative annual revenue, and transmits an notification message to the operation management device 400 of an operator. For example, at the time of year Y+1, the server 500 quarterly predicts a sales trend based on sales data of last year and previous cumulative data and transmits an notification message to the operation management device 400.

FIG. 13 shows sales analysis information output by the operation management device 400. The server 500 generates sales analysis information and transmits the sales analysis information to the operation management device 400. The operation management device 400 outputs the sales analysis information on a screen thereof, as shown in FIG. 13.

An operator may ascertain detailed analysis results by clicking on a specific quarter displayed on the screen or clicking on annual analysis data 61, 62, 63.

For example, when the operator clicks on 61a on the screen, the server 500 transmits results of analyzing revenue in the spring of year Y (lowest/highest revenue at a time point where transition between quarters occurs) and an alert message corresponding thereto to the operation management device 400. The operation management device 400 outputs the alert message on the screen. The alarm message may say, “Sales in June were low and sales in May were high, so we propose a promotion for attracting customers in June”.

Similarly, when an operator clicks on 62a on the screen, the server 500 transmits analysis results on annually accumulated lowest/highest revenue at a time point where transition between quarters occurs in year Y+1 and an alert message corresponding thereto to the operation management device 400. The operation management device 400 outputs the alert message on the screen. The alert message may say, “Every August, lots of customers visit your shop, so prepare for operation in August. For additional device installation, please contact us”.

When an operator clicks on a final time point 62b of each year on the screen, the server 500 transmits analysis results on annual sales and an notification message to the operation management device 400. For example, the alarm message may say, “Analysis on cumulative annual data shows that highest sales were recorded in October and lowest sales were recorded in February. Consider adding devices and events”.

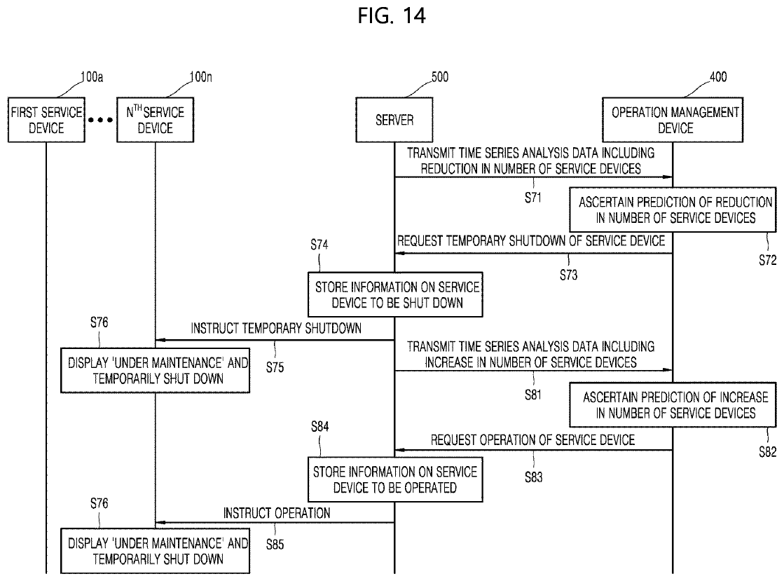

FIG. 14 shows a process of incorporating the number of operable service devices in a store into time series analysis data according to one embodiment of the present invention. In one embodiment, in generation of forecast data on increase/decrease in sales, which is included in the time series analysis data, the server controller 550 may incorporate the number of service devices to be temporarily shut down and the number of service devices to be additionally installed into the forecast data.

In the embodiment shown in FIG. 14, the server controller 550 cumulatively stores payment information on each service device 100 in the database 510. Then, the server controller 550 calculates a degree of association between use of the service devices 100 and increase/decrease in sales. Here, the server controller 550 may calculate a degree of association between use of any individual service device and increase/decrease in sales, or may calculate a degree of association between use of all the service devices in the store and increase/decrease in sales.

Here, the expression “the degree of association of use of any individual service device with increase/decrease in sales” refers to a degree of association of sales with users' preference for a specific service device. By way of example, a use frequency of a specific service device may vary depending upon locations thereof. In this case, a service device that is rarely used may be temporarily shut down at the time when decline in sales is expected.

In one embodiment, when decrease in sales is expected, the server controller 550 selects service devices whose use frequency is expected to drastically decrease with decrease in sales. Then, the server controller 550 may put the selected service devices on a ‘temporary shutdown’ list and may incorporate the list into the forecast data.

In another embodiment, when store sales are low, the server controller 550 selects service devices having a high use frequency. Then, the server controller 550 may put the selected service devices on a ‘temporary shutdown’ list and may incorporate the list into the forecast data. According to this embodiment, the service life of service devices having a high use frequency can be increased by being temporarily shut down.

The server controller 550 incorporates information on the number or type of service devices to be added into the forecast data.

The server 500 transmits time series analysis data including information on reduction in number of available service devices, generated in the aforementioned process, to the operation management device 400 (S71). The operation management device 400 ascertains that the time series analysis data includes information predicting reduction in number of available service devices (S72). Then, the operation management device 400 requests the server 500 to temporally shut down some service devices (S73).

The server 500 stores information on a service device to be shut down (S74) and instructs the corresponding service device 100n to temporally stop operation (S75). The service device 100n instructed to temporally stop operation displays a notice “under maintenance” and stops operation (S76).

In addition, when the server controller 550 determines that increase in sales is expected, the server 500 transmits time series analysis data including information on increase in number of available service devices to the operation management device 400 (S81). The operation management device 400 ascertains that the time series analysis data includes information predicting increase in number of available service devices (S82). Then, the operation management device 400 requests the server 500 to resume operation of some service devices (S83).

The server 500 stores information on a service device 100n that will resume operation (S84) and instructs the corresponding service device 100n to operate (S85). The service device 100n instructed to operate displays a notice “in operation” and starts operation (S86).

In addition, when the server 500 transmits the time series analysis data including information on increase in available service devices with all currently installed service devices being in operation, the operation management device 400 may request the server 500 to provide additional installation of a service device. In this case, the server 500 may deliver a new service device to the store.

The server controller 550 may store payment information on each service device 100 and may calculate a degree of usage of each service device based on usage information (payment information and operation information) on each service device.

In particular, for a store in which service devices having different functions, such as drying machines and washing machines are installed, the server 500 calculates a degree of contribution to sales and degree of association with sales for each service device. Therefore, according to the embodiment shown in FIG. 14, the server 500 can induce increase in sales and reduction in costs by transmitting a suitable alert message for increase in sales to the operation management device 400, wherein the alert message includes a message suggesting addition, temporary shutdown, or replacement of service devices to an operator.

In the embodiments of the present invention, daily/weekly/monthly/yearly revenue of a store in which plural service devices are installed are accumulated into big data and analyzed by a server. In addition, the server transmits a customized notification message to a customer device of a user of the store and an operation management device of an operator based on the analyzed data.

Although all the elements constituting the embodiments of the present invention have been described as being combined into one or combined with one another to operate, it should be understood that the present invention is not limited thereto and at least one of the elements may be selectively combined with one another to operate. Further, all the elements may be implemented as respective independent hardware devices, but some or all of the elements may also be selectively combined and implemented in the form of a computer program having program modules which perform some or all of the functions combined by one or more hardware devices. Code and code segments constituting the computer program may be easily conceived by those skilled in the art. Such a computer program is stored in computer readable storage media and is read and executed by the computer to implement the embodiments of the present invention. Examples of the storage media for storing the computer program may include magnetic recording media, optical recording media, semiconductor recording media, etc. In addition, the computer program for implementing the embodiments of the present invention includes a program module that is transmitted in real time via an external device.

Although some embodiments have been described herein, it should be understood that these embodiments are provided for illustration only and are not to be construed in any way as limiting the present invention, and that various modifications, changes, alterations, and equivalent embodiments can be made by those skilled in the art without departing from the spirit and scope of the invention. The scope of the present invention should be defined by the appended claims and equivalents thereof.

<List of Reference Numerals>

| | |
|---|---|
| 100: Service device | 200: Customer device |
| 400: Operation management device | 500: Server |

1. A server for analyzing store revenue data, comprising:
a communication unit receiving payment information and operation information from a service device;
a database storing the payment information and the operation information; and
a server controller generating time series analysis data comprising forecast data on increase/decrease in sales using identification information on a store in which the service device is installed, the payment information, and the operation information,
wherein the server controller generates the time series analysis data based on the store or based on stores in a group to which the store belongs, and the communication unit transmits the time series analysis data to an operation management device.

2. The server according to claim 1, wherein, when the server controller ascertains decrease in sales or ascertains an amount of the decrease in sales or the number of decreased sales from the forecast data, the communication unit transmits a message indicating that decline in sales is expected to the operation management device.

3. The server according to claim 2, wherein the message indicating that decline in sales is expected comprises promotion information, and the server controller generates the promotion information based on the number of service devices in the store or previous promotion information on the stores in the group.

4. The server according to claim 2, wherein, when the communication unit receives a promotion request message from the operation management device, the server controller transmits the promotion information to plural customer devices selected from among customer devices that registered the store based on promotion selection criteria.

5. The server according to claim 1, wherein the server controller generates the time series analysis data by accumulating the payment information on a certain periodic basis and comparing the accumulated payment information with previous payment information accumulated on the same periodic basis.

6. The server according to claim 1, wherein the server controller cumulatively stores the payment information on each service device in the database, calculates a degree of association of use of the service device with increase/decrease in sales, and incorporates information on the number or type of service devices to be added into the forecast data.

7. A method of analyzing store revenue data, comprising:
receiving, by a communication unit of a server, payment information and operation information from a service device;
storing, by a database of the server, the payment information and the operation information;
generating, by a server controller of the server, time series analysis data including forecast data on increase/decrease in sales using identification information on a store in which the service device is installed, the payment information, and the operation information; and
transmitting, by the communication unit of the server, the time series analysis data to an operation management device,
wherein the server controller generates the time series analysis data based on the store or based on stores in a group to which the store belongs.

8. The method of analyzing store revenue data according to claim 7, further comprising:
transmitting, by the communication unit, a message indicating that decline in sales is expected to the operation management device when the server controller ascertains decrease in sales or ascertains an amount of the decrease in sales or the number of decreased sales from the forecast data.

9. The method of analyzing store revenue data according to claim 8, further comprising:
generating, by the server controller, promotion information based on the number of service devices in the store or previous promotion information on the stores in the group
wherein the message indicating that decline in sales is expected comprises the promotion information.

10. The method of analyzing store revenue data according to claim 8, further comprising:
transmitting, by the server controller, the promotion information to plural customer devices selected from among customer devices that registered the store based on promotion selection criteria when the communication unit receives a promotion request message from the operation management device.

11. The method of analyzing store revenue data according to claim 7, further comprising:
generating, by the server controller, the time series analysis data by accumulating the payment information on a certain periodic basis and comparing the accumulated payment information with previous payment information accumulated on the same periodic basis.

12. The method of analyzing store revenue data according to claim 7, further comprising:
cumulatively storing, by the server controller, the payment information on each service device in the database;
calculating, by the server controller, a degree of association of use of the service device with increase/decrease in sales; and
incorporating, by the server controller, information on the number or type of service devices to be added into the forecast data.
